(19) United States
(12) Patent Application Publication
(10) Pub. No.: US 2021/0141362 A1
(43) Pub. Date: May 13, 2021

(54) APPARATUSES AND DEVICES FOR FACILITATING ENHANCING OPERATIONS OF A COMPUTER NUMERICAL CONTROL (CNC) CUTTING MACHINE

(71) Applicants: Benjamin Boyd Cramer, Varysburg, NY (US); Nicholas Anthony Sinno, South Wales, NY (US); James Paul Tuttle, Delevan, NY (US); Timothy Joslin, Strykersville, NY (US)

(72) Inventors: Benjamin Boyd Cramer, Varysburg, NY (US); Nicholas Anthony Sinno, South Wales, NY (US); James Paul Tuttle, Delevan, NY (US); Timothy Joslin, Strykersville, NY (US)

(21) Appl. No.: 17/093,489

(22) Filed: Nov. 9, 2020

Related U.S. Application Data
(60) Provisional application No. 62/932,911, filed on Nov. 8, 2019.

(51) Int. Cl. G05B 19/4093; G05B 19/18; G05B 19/401; G05B 19/409

(52) U.S. Cl. CPC G05B 19/40938; G05B 19/409; G05B 19/401; G05B 19/182

(57) ABSTRACT

Disclosed herein is an apparatus for facilitating enhancing operations of a computer numerical control (CNC) cutting machine, in accordance with some embodiments. Further, the CNC cutting machine comprises a support table, a gantry, a carriage, and a main cutting tool. Further, the gantry is configured to move vertically along a length of the support table and the carriage is configured to move horizontally on the gantry along a length of the gantry defining an operation area on the support table. Accordingly, the apparatus comprises an extension device. Further, the extension device comprises a first end and a second end. Further, the first end is attachable to a carriage housing of the carriage and a tool holder is comprised in the second end. Further, the extension device is configured to extend between two positions. Further, the tool holder is configured for removably holding an auxiliary cutting tool.

The current application claims a priority to the U.S. Provisional Patent application Ser. No. 62/932,911 filed on Nov. 9, 2019.

### FIELD OF THE INVENTION

Generally, the present disclosure relates to a field of miscellaneous hardware. More specifically, the present disclosure relates to apparatuses and devices for facilitating enhancing operations of a computer numerical control (CNC) cutting machine.

### BACKGROUND OF THE INVENTION

CNC cutting machines are used in industry to cut metal. Further, a CNC cutting machine is used to cut various types of metal plates up to about two inches in thickness by directing a hot plasma arc through a cutting torch having a nozzle while moving the cutting torch relative to the plate. An oxy-fuel cutting machine of the CNC cutting machine is used to cut ferrous, mild, and low-alloy steels in thicknesses up to three feet or more. In the oxy-fuel cutting machine, an oxygen/fuel gas flame preheats the metal to its ignition temperature, and a high-power oxygen jet is directed through a cutting torch at the metal creating a chemical reaction between the oxygen and the metal to form iron oxide, also known as slag. The high-power oxygen jet removes the slag from the kerf. Similar to plasma cutting, the oxy-fuel cutting torch is moved relative to the metal being cut. The CNC cutting machine is known to have a support table on which a metal plate is positioned horizontally for cutting, a transverse gantry spanning the support table along a first horizontal axis and movable relative to the support table along a second horizontal axis orthogonal to the first horizontal axis, and a carriage of the CNC cutting machine is mounted on the gantry to travel along the gantry. A cutting torch is mounted on the carriage. Where the cutting torch is an oxy-fuel cutting torch, it connects to hoses for supplying oxygen, and for preheating oxygen and fuel gas. Where the cutting torch is a plasma cutting torch, it connects to hoses for supplying plasma gas, hoses for supplying and delivering cooling water, and cables for electricity. Further, the cutting torch may be moved horizontally in an XY plane by CNC commands driving motion of the carriage along the gantry, and by CNC commands driving motion of the gantry along the table. Further, the cutting machine having the configuration described above are inherently limited with respect to available XY cutting area by travel limits of the carriage along the gantry, and by travel limits of the gantry along the table. Thus, jobs requiring a slightly larger cutting area along the X and/or Y-axis cannot be undertaken on the cutting machine, even if the material to be cut is capable of being supported by the cutting machine. Further, the CNC cutting machine is also known to cut lengths of pipe and lengths of structural steel using a cutting torch, e.g. a plasma cutting torch or an oxy-fuel cutting torch. For these jobs, it is advantageous that the workpiece is supported at one end and automatically rotated about a longitudinal axis of the workpiece relative to the cutting torch, which may be positioned at a desired axial location along the length of the workpiece. The XY table of the cutting machine described above may be configured with an optional pipe rotator, however, such an option subtracts from the available cutting area on the support table for normal cutting jobs such as plate cutting.

Therefore, there is a need for improved apparatuses and devices for facilitating enhancing operations of a computer numerical control (CNC) cutting machine that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is an apparatus for facilitating enhancing operations of a computer numerical control (CNC) cutting machine, in accordance with some embodiments. Further, the CNC cutting machine may include a support table, a gantry, a carriage, and a main cutting tool. Further, the gantry may be movably attached to the support table. Further, the carriage may be movably mounted on the gantry. Further, the main cutting tool may be attached to the carriage. Further, the gantry may transversely extend on the support table. Further, the gantry may be configured to move vertically along a length of the support table and the carriage may be configured to move horizontally on the gantry along a length of the gantry defining an operation area on the support table. Further, the CNC cutting machine may perform at least one operation using the main cutting tool on at least one object disposable on the support table within the operation area. Accordingly, the apparatus may include an extension device. Further, the extension device may be attachable to the carriage of the CNC cutting machine. Further, the extension device may include a first end and a second end. Further, the first end may be attachable to a carriage housing of the carriage. Further, the extension device may be configured to extend between at least two positions. Further, the extension device may include at least one tool holder comprised in the second end. Further, the at least one tool holder may be configured for removably holding at least one auxiliary cutting tool. Further, the CNC cutting machine may perform the at least one operation on the at least one object using the at least one auxiliary cutting tool.

Further disclosed herein is an apparatus for facilitating enhancing operations of a computer numerical control (CNC) cutting machine, in accordance with some embodiments. Further, the CNC cutting machine may include a support table, a gantry, a carriage, and a main cutting tool. Further, the gantry may be movably attached to the support table. Further, the carriage may be movably mounted on the gantry. Further, the main cutting tool may be attached to the carriage. Further, the gantry may transversely extend on the support table. Further, the gantry may be configured to move vertically along a length of the support table and the carriage may be configured to move horizontally on the gantry along a length of the gantry defining an operation area on the support table. Further, the CNC cutting machine may perform at least one operation using the main cutting tool on at least one object disposable on the support table within the operation area. Accordingly, the apparatus may include an extension device. Further, the extension device may be attachable to the carriage of the CNC cutting machine. Further, the extension device may include a first end and a second end. Further, the first end may be attachable to a carriage housing of the carriage. Further, the extension device may be configured to extend between at least two positions. Further, the extension device may include at least one tool holder comprised in the second end. Further, the at least one tool holder may be configured for removably holding at least one auxiliary cutting tool. Further, the CNC cutting machine may perform the at least one operation on the at least one object using the at least one auxiliary cutting tool. Further, the extension device may include at least one ear plate and an extension arm. Further, the at least one ear plate may include a primary end and a secondary end. Further, the primary end may form the first end. Further, the primary end may be attachable to the carriage housing of the carriage using at least one attaching element. Further, the extension arm may extend between a proximal end and a distal end. Further, the distal end may form the second end. Further, the at least one tool holder may be comprised in the distal end. Further, the proximal end may be pivotally coupled with the secondary end using at least one pivot element for selectively pivoting the extension arm in relation to the at least one ear plate about a transverse axis defined by the at least one pivot element between the at least two positions. Further, the at least two positions may include at least one vertical storage position and at least one horizontal extended position.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a perspective view of an apparatus for facilitating enhancing operations of a computer numerical control (CNC) cutting machine with the CNC cutting machine, in accordance with some embodiments.

FIG. 2 is a side view of the apparatus attached to the CNC cutting machine, in accordance with some embodiments.

FIG. 3 is a perspective view of the extension device of the apparatus in the at least one vertical storage position, in accordance with some embodiments.

FIG. 4 is a perspective view of the extension device of the apparatus in the at least one horizontal extended position, in accordance with some embodiments.

FIG. 5 is a right perspective view of the rotator apparatus of the apparatus, in accordance with some embodiments.

FIG. 6 is a left perspective view of the rotator apparatus of the apparatus, in accordance with some embodiments.

FIG. 7 is a front perspective view of the headstock assembly of the rotator apparatus, in accordance with some embodiments.

FIG. 8 is a cross-sectional view of the headstock assembly of FIG. 7 taken along a line A-B, in accordance with some embodiments.

FIG. 9 is a rear perspective view of the headstock assembly of the rotator apparatus, in accordance with some embodiments.

FIG. 10 is a front perspective view of the headstock assembly without the front wall, in accordance with some embodiments.

FIG. 11 is a perspective view of a pipe support assembly of the rotator apparatus, in accordance with some embodiments.

FIG. 12 is a perspective view of a debris trough of the rotator apparatus, in accordance with some embodiments.

FIG. 13 is a perspective view of an apparatus for facilitating enhancing operations of a computer numerical control (CNC) cutting machine with the CNC cutting machine, in accordance with some embodiments.

FIG. 14 is a perspective view of the extension device of the apparatus in the at least one vertical storage position, in accordance with some embodiments.

FIG. 15 is a perspective view of the extension device of the apparatus in the at least one horizontal extended position, in accordance with some embodiments.

FIG. 16 is a perspective view of a CNC plasma and/or oxy-fuel cutting machine, in accordance with some embodiments.

FIG. 17 is a perspective view of the carriage of the CNC plasma and/or oxy-fuel cutting machine 10 in a vertical storage position, in accordance with some embodiments.

FIG. 18 is a perspective view of the carriage of the CNC plasma and/or oxy-fuel cutting machine in the horizontal extended position, in accordance with some embodiments.

FIG. 19 is a partial side view of the CNC plasma and/or oxy-fuel cutting machine, in accordance with some embodiments.

FIG. 20 is a right perspective view of a pipe rotator apparatus of the CNC plasma and/or oxy-fuel cutting machine, in accordance with some embodiments.

FIG. 21 is a left perspective view of the pipe rotator apparatus of the CNC plasma and/or oxy-fuel cutting machine, in accordance with some embodiments.

FIG. 22 is a perspective view of the support assembly of the pipe rotator apparatus, in accordance with some embodiments.

FIG. 23 is a perspective view of the debris trough of the pipe rotator apparatus, in accordance with some embodiments.

FIG. 24 is a rear perspective view of the headstock assembly of the pipe rotator apparatus, in accordance with some embodiments.

FIG. 25 is a front perspective view of the headstock assembly of the pipe rotator apparatus, in accordance with some embodiments.

FIG. 26 is a front perspective view of the headstock assembly without the front wall, in accordance with some embodiments.

FIG. 27 is a cross-sectional view of the headstock assembly of FIG. 25 taken along a line X-Y, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.” The following detailed description refers to the accompanying drawings.

Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of apparatuses and devices for facilitating enhancing operations of a computer numerical control (CNC) cutting machine, embodiments of the present disclosure are not limited to use only in this context.

Overview:

The present disclosure describes apparatuses and devices for facilitating enhancing operations of a computer numerical control (CNC) cutting machine. Further, the disclosed apparatuses and devices include a torch carriage for the CNC cutting machine that has a pair of torch holders, wherein one of the torch holders is mounted on an adjustable extension arm of a carriage of the CNC cutting machine so that a cutting torch may be mounted at either a standard position on the carriage or at an extended position on the carriage to extend a cutting range of the CNC cutting machine.

Further, the disclosed apparatuses and devices include a pipe rotator apparatus which is retrofittable onto the CNC cutting machine. The pipe rotator apparatus may include a headstock assembly, one or more pipe support assemblies, and one or more debris troughs all mountable onto an existing support table of a cutting machine. Further, the headstock assembly may include an internal spark arrestor.

Further, the present disclosure describes a cutting machine. Further, the cutting machine may include a torch carriage. Further, the cutting machine may include a pipe rotator apparatus. Further, the pipe rotator apparatus may include a headstock assembly having an internal spark arrestor.

Further, the present disclosure describes a torch carriage for a CNC cutting machine that includes a pair of torch holders, wherein one of the torch holders is mounted on an adjustable extension arm of a carriage of the CNC cutting machine so that a cutting torch may be mounted at either a standard position on the carriage or at an extended position on the carriage to extend a cutting range of the CNC cutting machine. Further, the present disclosure describes a pipe rotator apparatus which is retrofittable onto the CNC plasma cutting machine. Further, the pipe rotator includes a headstock assembly, one or more pipe support assemblies, and one or more debris troughs. Further, the headstock assembly, the one or more pipe support assemblies, and the one or more debris troughs are mountable onto an existing support table of the cutting machine. The headstock assembly may include an internal spark arrestor.

Further, the present disclosure describes modular enhancements for a computer numerical control cutting machine. Further, the present disclosure relates to optional modular enhancements which may be added to a computer numerical control (CNC) cutting machine to improve its functionality.

Further, the present disclosure describes an apparatus that may be used to extend a cutting head of a CNC cutting machine beyond an inherent cutting area of the CNC cutting machine, in the longitudinal direction, and to provide expanded functionality to an existing CNC cutting machine. Further, an expanded cutting area apart from the inherent cutting area cannot be defined as part of the inherent cutting area of the existing CNC cutting machine. Further, the apparatus may expand the functionality of the cutting head outside of its normal area of operation. Further, the apparatus retains the ability for X, Y cutting of the CNC cutting machine regardless of the extension position of the apparatus. The extension arm's of the apparatus's primary purpose is to allow the CNC cutting machine to operate in the −X, −Y quadrants while retaining the ability to quickly change over and continue to use the full X, Y cutting area. Further, the apparatus allows for the changing of cutting tools. Further, the cutting tools may include plasma torches, oxy-fuel torches, scribe markers, etc. Further, the cutting tools may be removably mounted on an extension bracket of the apparatus. The extension bracket is held in position by lock bolts and pivot pins with tools being held in place by magnets. Use of proximity switches on the plasma torches are functional and proximity switches can be added to any tool if needed.

FIG. 1 is a perspective view of an apparatus 100 for facilitating enhancing operations of a computer numerical control (CNC) cutting machine 102 with the CNC cutting machine 102, in accordance with some embodiments. Further, the CNC cutting machine 102 may include a computer numerical control (CNC) plasma and oxy-fuel cutting machine. Further, the CNC cutting machine 102 may include a support table 104, a gantry 106, a carriage 108, and a main cutting tool 110. Further, the main cutting tool 110 may include at least one torch. Further, the at least one torch may include at least one plasma torch, at least one oxy-fuel torch, etc. Further, the gantry 106 may be movably attached to the support table 104. Further, the carriage 108 may be movably mounted on the gantry 106. Further, the main cutting tool 110 may be attached to the carriage 108. Further, the gantry 106 may transversely extend on the support table 104. Further, the gantry 106 may be configured to move vertically along a length of the support table 104 and the carriage 108 may be configured to move horizontally on the gantry 106 along a length of the gantry 106 defining an operation area on the support table 104. Further, the operation area may be defined as a movement of the gantry 106 along a first horizontal axis and a movement of the carriage 108 along a second horizontal axis orthogonal to the first horizontal axis. Further, the first horizontal axis may be X-axis and the second horizontal axis may be Y-axis. Further, the operation area may be an X-Y plane. Further, the operation area may be a cutting area. Further, the CNC cutting machine 102 may perform at least one operation using the main cutting tool 110 on at least one object disposable on the support table 104 within the operation area. Further, the at least one operation may include cutting, drilling, milling, etc. Further, the apparatus 100 may include an extension device 114. Further, the at least one object may include a sheet, a pipe, etc. of at least one material. Further, the at least one material may include metal, wood, plastic, etc.

Further, the extension device 114 may be attachable to the carriage 108 of the CNC cutting machine 102. Further, the extension device 114 may include a first end 116 and a second end 118. Further, the first end 116 may be attachable to a carriage housing 120 of the carriage 108. Further, the extension device 114 may be configured to extend between at least two positions. Further, the extension device 114 may be configured to retractably extend between the at least two positions. Further, the extension device 114 may include at least one tool holder 122 comprised in the second end 118. Further, the at least one tool holder 122 may be configured for removably holding at least one auxiliary cutting tool 202, as shown in FIG. 2. Further, the at least one auxiliary cutting tool 202 may include at least one auxiliary torch. Further, the at least one auxiliary torch may include at least one plasma torch, at least one oxy-fuel torch, etc. Further, the CNC cutting machine 102 may perform the at least one operation on the at least one object using the at least one auxiliary cutting tool 202.

Further, in some embodiments, the extension device 114 may include at least one ear plate 302, as shown in FIG. 3, and an extension arm 304, as shown in FIG. 3. Further, the at least one ear plate 302 may include a primary end 306 and a secondary end 308. Further, the primary end 306 may form the first end 116. Further, the primary end 306 may be attachable to the carriage housing 120 of the carriage 108 using at least one attaching element 310-312. Further, in an embodiment, the at least one ear plate 302 may include at least one clamping lever 314 configured to be removably mated with at least one slot 316 comprised in at least one proximal portion of the extension arm 304 for releasably holding the extension arm 304 in at least one selected position of the at least two positions. Further, the extension arm 304 may extend between a proximal end 318 and a distal end 320. Further, the distal end 320 may form the second end 118. Further, the at least one tool holder 122 may be comprised in the distal end 320. Further, the proximal end 318 may be pivotally coupled with the secondary end 308 using at least one pivot element 322 for selectively pivoting the extension arm 304 in relation to the at least one ear plate 302 about a transverse axis defined by the at least one pivot element 322 between the at least two positions. Further, the at least one pivot element 322 may include at least one pivot pin. Further, the at least two positions may include at least one vertical storage position and at least one horizontal extended position. Further, in an embodiment, the extension arm 304 may be associated with a length defined between the proximal end 318 and the distal end 320. Further, the extension arm 304 may transversely extend on the support table 104 in at least a part of the length of the extension arm 304 and the at least one horizontal extended position for defining an extended operation area beyond at least one side of the operation area. Further, the CNC cutting machine 102 may perform the at least one operation using the at least one auxiliary cutting tool 202 on the at least one object disposed within the extended operation area. Further, in an embodiment, the proximal end 318 of the extension arm 304 may be pivotally coupled with the secondary end 308 of the at least one ear plate 302 using the at least one pivot element 322 for selectively pivoting the extension arm 304 in relation to the at least one ear plate 302 about a longitudinal axis defined by the at least one pivot element 322 between a plurality of first positions in the at least one horizontal extended position. Further, the longitudinal axis may be orthogonal to the transverse axis. Further, in an embodiment, the extension arm 304 in a first position of the plurality of first positions may be configured for defining a first extended operation area beyond the operation area on at least one first side of the operation area in the at least one horizontal extended position of the extension arm 304 based on the selectively pivoting of the extension arm 304 in relation to the at least one ear plate 302 about the longitudinal axis. Further, the CNC cutting machine 102 may perform the at least one operation using the at least one auxiliary cutting tool 202 on the at least one object disposed within the first extended operation area. Further, in an embodiment, the support table 104 may be configured for supporting the at least one object disposed within a top surface area of a top surface 124 of the support table 104. Further, the top surface area may include the operation area. Further, the CNC machine may perform the at least one operation on the at least one object disposed within the top surface area based on the supporting. In further embodiments, at least one mounting apparatus 126 may be mountable on at least one side of the support table 104 using at least one fastening mechanism. Further, the at least one mounting apparatus 126 may be configured for supporting the at least one object disposed within at least one of the extended operation area and the first extended operation area. Further, the CNC machine may perform the at least one operation on the at least one object disposed within the at least one of the extended operation area and the first extended operation area based on the supporting. Further, in an embodiment, the at least one mounting apparatus 126 may include a rotator apparatus 128. Further, the rotator apparatus 128 may include a headstock assembly 502, as shown in FIG. 5, one or more pipe support assemblies 514-522, as shown in FIG. 5, and one or more debris troughs 504-512, as shown in FIG. 5. Further, the one or more pipe support assemblies 514-522 may be mounted on the at least one side of the support table 104. Further, the one or more pipe support assemblies 514-522 may be configured for rotatably supporting the at least one object disposed on the one or more pipe support assemblies 514-522. Further, in an embodiment, the one or more debris troughs 504-512 may be mounted on the at least one side of the support table 104. Further, the one or more debris troughs 504-512 may form one or more receptacles. Further, the one or more debris troughs 504-512 may be configured for receiving at least one scrap material generated by the at least one object based on the at least one operation performed on the at least one object. Further, in an embodiment, the headstock assembly 502 may be mounted on the at least one side of the support table 104. Further, the headstock assembly 502 may include a gearbox 524. Further, an input shaft of the gearbox 524 may be couplable with an output motor shaft of a drive motor. Further, the drive motor may rotate the output motor shaft. Further, the headstock assembly 502 may include a chuck 602, as shown in FIG. 6. Further, a rear end 830 of the chuck 602 may be rotatably coupled with an output shaft of the gearbox 524. Further, a front end 604 of the chuck 602 may be configured to be rotatably coupled with a first end of the at least one object. Further, the chuck 602 may be configured to rotate the at least one object based on a rotation received by the chuck 602 on the rear end 830 of the chuck 602 through the output shaft. Further, in an embodiment, the headstock assembly 502 may include a spark arrestor 802, as shown in FIG. 8, disposed within a housing 706, as shown in FIG. 7, of the headstock assembly 502. Further, the spark arrestor 802 may be configured for arresting at least one spark generated by the at least one object. Further, the spark arrestor 802 may be configured to cooperate with a fume collector connectable to an outlet port 828, as shown in FIG. 8, disposed on the housing 706. Further, the fume collector may be configurable for drawing air from at least one region associated with the at least one object through the housing 706. Further, the drawing of the air may draw the at least one spark into the spark arrestor 802. Further, the at least one spark may be extinguished by coming in contact with at least one surface of the spark arrestor 802. Further, in an embodiment, the spark arrestor 802 may include a plurality of cylindrical rings. Further, the plurality of cylindrical rings may be disposed coaxially. Further, the plurality of cylindrical rings may be radially nested and axially offsetted. Further, the plurality of cylindrical rings may include a plurality of first cylindrical rings 804-806 and a plurality of second cylindrical rings 808-810. Further, a primary end 812-814 of each first cylindrical ring of the plurality of first cylindrical rings 804-806 may be attached to an inner surface of a front wall 702, as shown in FIG. 7, of the housing 706. Further, a primary end 820-822 of each second cylindrical ring of the plurality of second cylindrical rings 808-810 may be attached to an inner surface of a rear wall 704, as shown in FIG. 7, of the housing 706. Further, the each first cylindrical ring partially encompasses the each second cylindrical ring providing a radial gap between the each first cylindrical ring and the each second cylindrical ring. Further, a secondary end 816-818 of the each first cylindrical ring may not be attached to the inner surface of the rear wall 704. Further, a secondary end 824-826 of the each second cylindrical ring may not be attached to the inner surface of the front wall 702. Further, the plurality of cylindrical rings may be configured for forming a plurality of paths for the at least one spark based on coaxially disposing of the plurality of cylindrical rings and radially nesting and axially offsetting of the plurality of cylindrical rings. Further, the at least one spark may travel through the plurality of paths for coming in contact with the at least one surface of the spark arrestor 802.

Further, in some embodiments, the extension device 114 may be detachably attachable to the carriage 108 of the CNC cutting machine 102 using at least one attachment element. Further, a first attachment part of the at least one attachment element may be comprised in the first end 116 of the extension device 114 and a second attachment part of the at least one attachment element may be comprised in at least one portion of the carriage housing 120. Further, the first attachment part of the second attachment part may be configured to be detachably attached.

FIG. 2 is a side view of the apparatus 100 attached to the CNC cutting machine 102, in accordance with some embodiments.

FIG. 3 is a perspective view of the extension device 114 of the apparatus 100 in the at least one vertical storage position, in accordance with some embodiments.

FIG. 4 is a perspective view of the extension device 114 of the apparatus 100 in the at least one horizontal extended position, in accordance with some embodiments.

FIG. 5 is a right perspective view of the rotator apparatus 128 of the apparatus 100, in accordance with some embodiments.

FIG. 6 is a left perspective view of the rotator apparatus 128 of the apparatus 100, in accordance with some embodiments.

FIG. 7 is a front perspective view of the headstock assembly 502 of the rotator apparatus 128, in accordance with some embodiments.

FIG. 8 is a cross-sectional view of the headstock assembly 502 of FIG. 7 taken along a line A-B, in accordance with some embodiments.

FIG. 9 is a rear perspective view of the headstock assembly 502 of the rotator apparatus 128, in accordance with some embodiments.

FIG. 10 is a front perspective view of the headstock assembly 502 without the front wall 702, in accordance with some embodiments.

FIG. 11 is a perspective view of a pipe support assembly 1100 of the rotator apparatus 128, in accordance with some embodiments.

FIG. 12 is a perspective view of a debris trough 1200 of the rotator apparatus 128, in accordance with some embodiments.

FIG. 13 is a perspective view of an apparatus 1300 for facilitating enhancing operations of a computer numerical control (CNC) cutting machine 1302 with the CNC cutting machine 1302, in accordance with some embodiments. Further, the CNC cutting machine 1302 may include a support table 1304, a gantry 1306, a carriage 1308, and a main cutting tool 1310. Further, the gantry 1306 may be movably attached to the support table 1304. Further, the carriage 1308 may be movably mounted on the gantry 1306. Further, the main cutting tool 1310 may be attached to the carriage 1308. Further, the gantry 1306 may transversely extend on the support table 1304. Further, the gantry 1306 may be configured to move vertically along a length of the support table 1304 and the carriage 1308 may be configured to move horizontally on the gantry 1306 along a length of the gantry 1306 defining an operation area on the support table 1304. Further, the CNC cutting machine 1302 may perform at least one operation using the main cutting tool 1310 on at least one object disposable on the support table 1304 within the operation area. Further, the apparatus 1300 may include an extension device 1314.

Further, the extension device 1314 may be attachable to the carriage 1308 of the CNC cutting machine 1302. Further, the extension device 1314 may include a first end 1316 and a second end 1318. Further, the first end 1316 may be attachable to a carriage housing 1320 of the carriage 1308. Further, the extension device 1314 may be configured to extend between at least two positions. Further, the extension device 1314 may include at least one tool holder 1322 comprised in the second end 1318. Further, the at least one tool holder 1322 may be configured for removably holding at least one auxiliary cutting tool 1502. Further, the CNC cutting machine 1302 may perform the at least one operation on the at least one object using the at least one auxiliary cutting tool 1502. Further, the extension device 1314 may include at least one ear plate 1402, as shown in FIG. 14, and an extension arm 1404, as shown in FIG. 14. Further, the at least one ear plate 1402 may include a primary end 1406 and a secondary end 1408. Further, the primary end 1406 may form the first end 1316. Further, the primary end 1406 may be attachable to the carriage housing 1320 of the carriage 1308 using at least one attaching element 1410-1412. Further, the extension arm 1404 may extend between a proximal end 1418 and a distal end 1420. Further, the distal end 1420 may form the second end 1318. Further, the at least one tool holder 1322 may be comprised in the distal end 1420. Further, the proximal end 1418 may be pivotally coupled with the secondary end 1408 using at least one pivot element 1422 for selectively pivoting the extension arm 1404 in relation to the at least one ear plate 1402 about a transverse axis defined by the at least one pivot element 1422 between the at least two positions. Further, the at least two positions may include at least one vertical storage position and at least one horizontal extended position.

Further, in some embodiments, the extension arm 1404 may be associated with a length defined between the proximal end 1418 and the distal end 1420. Further, the extension arm 1404 may transversely extend on the support table 1304 in at least a part of the length of the extension arm 1404 and the at least one horizontal extended position for defining an extended operation area beyond at least one side of the operation area. Further, the CNC cutting machine 1302 may perform the at least one operation using the at least one auxiliary cutting tool 1502 on the at least one object disposed within the extended operation area. Further, in an embodiment, the proximal end 1418 of the extension arm 1404 may be pivotally coupled with the secondary end 1408 of the at least one ear plate 1402 using the at least one pivot element 1422 for selectively pivoting the extension arm 1404 in relation to the at least one ear plate 1402 about a longitudinal axis defined by the at least one pivot element 1422 between a plurality of first positions in the at least one horizontal extended position. Further, the longitudinal axis may be orthogonal to the transverse axis. Further, in an embodiment, the extension arm 1404 in a first position of the plurality of first positions may be configured for defining a first extended operation area beyond the operation area on at least one first side of the operation area in the at least one horizontal extended position of the extension arm 1404 based on the selectively pivoting of the extension arm 1404 in relation to the at least one ear plate 1402 about the longitudinal axis. Further, the CNC cutting machine 1302 may perform the at least one operation using the at least one auxiliary cutting tool 1502 on the at least one object disposed within the first extended operation area.

Further, in some embodiments, the at least one ear plate 1402 may include at least one clamping lever 1414 configured to be removably mated with at least one slot 1416 comprised in at least one proximal portion of the extension arm 1404 for releasably holding the extension arm 1404 in at least one selected position of the at least two positions.

Further, in some embodiments, the extension device 1314 may be detachably attachable to the carriage 1308 of the CNC cutting machine 1302 using at least one attachment element. Further, a first attachment part of the at least one attachment element may be comprised in the first end 1316 of the extension device 1314 and a second attachment part of the at least one attachment element may be comprised in at least one portion of the carriage housing 1320. Further, the first attachment part of the second attachment part may be configured to be detachably attached.

FIG. 14 is a perspective view of the extension device 1314 of the apparatus 1300 in the at least one vertical storage position, in accordance with some embodiments.

FIG. 15 is a perspective view of the extension device 1314 of the apparatus 1300 in the at least one horizontal extended position, in accordance with some embodiments.

FIG. 16 is a perspective view of a CNC plasma and/or oxy-fuel cutting machine 10, in accordance with some embodiments. Further, the cutting machine 10 (the CNC plasma and/or oxy-fuel cutting machine 10) may comprise a support table 12 on which a metal plate (the at least one object) or other workpieces (such as the at least one object) may be positioned for cutting. Further, the cutting machine 10 may comprise a transverse gantry 14 and a carriage 20 mounted on the gantry 14, and a cutting torch 2 supported and carried by the carriage 20. Further, the gantry 14 spans the support table 12 along a first horizontal axis (e.g. the X-axis) and is movable relative to the support table 12 along a second horizontal axis (e.g. the Y-axis) orthogonal to the first horizontal axis. For example, the gantry 14 may have a pair of drive compartments 15 disposed at opposite ends thereof which enclose respective motor and drive gear assemblies for engaging a pair of tracks 16 extending parallel to the second horizontal axis. Further, the motors in the drive compartments 15 may be operated in a synchronized fashion to move the gantry 14 back and forth along the second horizontal axis. Further, the carriage 20 may include a carriage drive motor 21 connected to a drive gear engaged with the pair of tracks 16 on the gantry 14, whereby the carriage drive motor 21 is operable to move the carriage 20 side-to-side over the support table 12. Further, the cutting torch 2 is mounted on the carriage 20 and may be connected to supply hoses and/or electrical cables (not shown) depending on whether the cutting torch 2 is configured as an oxy-fuel torch or a plasma torch. Further, the cutting machine 10 may include computer controller (not shown) and a user interface 18, for example a touchscreen display, connected to the controller for enabling an operator to enter control commands and operating parameters, and to monitor cutting machine operation. Further, the cutting torch 2 may be moved horizontally in an XY plane by CNC motor drive commands issued by the controller to the carriage 20 and gantry drive motors for driving motion of the carriage 20 along the gantry 14, and for driving motion of the gantry 14 along the support table 12.

FIG. 17 is a perspective view of the carriage 20 of the CNC plasma and/or oxy-fuel cutting machine 10 in a vertical storage position, in accordance with some embodiments. In addition to the carriage motor 21, the carriage 20 may include a carriage housing 22, an extension arm 24 pivotally connected to the carriage housing 22 by a pair of pivot pins 25 for selective pivoting of the extension arm 24 relative to the carriage housing 22 about a transverse axis defined by the pair of pivot pins 25, a main torch holder 28 is mounted to the carriage housing 22 and an auxiliary torch holder 30 mounted to a distal end of the extension arm 24 spaced from the pair of pivot pins 25. Further, the extension arm 24 may be releasably held in a selected pivot position relative to the carriage housing 22 by a pair of clamping levers 26 respectively mated with a pair of arcuate slots 27 through the carriage housing 22. Further, the pair of arcuate slots 27 may be provided in a corresponding pair of ear plates 22A, 22B forming a part of the carriage housing 22. Further, the extension arm 24 may be adjusted relative to the carriage housing 22 between the vertical storage position and a horizontal extended position (as shown in FIG. 18). When the extension arm 24 is in the vertical storage position the cutting torch 2 may be removably mounted in and held by the main torch holder 28, and the auxiliary torch holder 30 may rest idle on the extension arm 24 just above the carriage housing 22. In this configuration, the cutting torch 2 is mounted in a standard position on the carriage 20. When the extension arm 24 is in the horizontal extended position the cutting torch 2 may be removably mounted in and held by the auxiliary torch holder 30, and the main torch holder 28 may rest idle in the carriage housing 22. In this configuration, the cutting torch 2 is mounted in the horizontal extended position on the carriage 20. Further, the extension arm 24 may have a channel-shaped cross-section allowing space for the cutting torch 2 and attached hoses when the cutting torch 2 is in it's the standard position and the extension arm 24 is in the vertical storage position.

FIG. 18 is a perspective view of the carriage 20 of the CNC plasma and/or oxy-fuel cutting machine 10 in the horizontal extended position, in accordance with some embodiments.

FIG. 19 is a partial side view of the CNC plasma and/or oxy-fuel cutting machine 10, in accordance with some embodiments. Further, the extension arm 24 with the auxiliary torch holder 30 increases the Y-axis range of a torch axis of the cutting torch 2 by a distance D relative to the standard torch position. Further, the extension arm 24 increases the torch axis of the cutting torch from a standard torch axis 31 to an extended torch axis 32. In an example embodiment, the length of the extension arm 24 may be chosen such that the distance D is approximately 13.75 inches, however, distance D may be more or less than 13.75 inches. When the cutting torch 2 is mounted in the extended position and gantry 14 is brought to a forward or front limit position relative to table 12, then the torch axis may extend beyond the surface of table 12. This feature enables the cutting machine 10 to cut oversize workpieces which could not be cut using only the standard torch position. Moreover, this feature enables the cutting machine 10 to be used for cutting operations involving a supplemental workpiece mounting apparatus which may be mounted along a front end of the support table 12.

FIG. 20 is a right perspective view of a pipe rotator apparatus 50 of the CNC plasma and/or oxy-fuel cutting machine 10, in accordance with some embodiments. Further, the pipe rotator apparatus 50 may be retrofitted onto the support table 12. Further, the pipe rotator apparatus 50 may generally comprise a headstock assembly 51, one or more pipe support assemblies 60, and one or more debris troughs 80. Further, the pipe rotator apparatus 50 may be provided as a kit that enables a customer to retrofit the CNC plasma and/or oxy-fuel cutting machine 10, with the pipe rotator apparatus 50. Further, the headstock assembly 51 may include a housing 52 having an outlet port 53 for communication with a separate fume collector (not shown) by way of a duct extending between the outlet port 53 and the fume collector. Further, the headstock assembly 51 may include a gearbox 54 to which a drive motor (not shown) may be connected and a chuck 56 connected to a rotary output shaft of the gearbox 54 for rotation with the output shaft. Further, the chuck 56, which may be a three-jaw chuck or another type of chuck, is operable to hold an end of a workpiece, such as a length of pipe or a length of structural steel. Further, the headstock assembly 51 may be similar to headstock assemblies commonly found in a lathes. Further, the headstock assembly 51 may be designed for mounting to a frame of the support table 12 of the cutting machine 10. Further, the headstock assembly 51 may be mounted on a front surface of a leg 12A of the support table 12. To facilitate mounting, the housing 52 may include an attachment wall 55 offset from a main portion of the housing 52 to provide a gap 57 between the attachment wall 55 and the rest of the housing 52, whereby threaded fasteners 58 may be accessed for the mounting of the headstock assembly 51 the cutting machine 10. Further, the pipe support assemblies 60 may be configured to rotatably support the workpiece at suitable intervals along the length of the workpiece to prevent the workpiece from drooping at its free (i.e. non-chucked) end due to gravity. Further, each support assembly 60, as shown in FIG. 22, may include a vertical threaded support shaft 61 on which a bifurcated support yoke 62 is mounted. Further, the bifurcated support yoke 62 may include a pair of angled legs 64 each having an elongated slot 65 for receiving a threaded stem of a corresponding ball bearing 66 mounted on the pair of angled leg 64, whereby the ball bearing 66 may be releasably fixed at a chosen location along the elongated slot 65 by tightening a clamping nut 67 mated with the threaded stem. In this way, the location of each ball bearing 66 is adjustable to adapt to differently dimensioned workpieces, for example pipes having different outer diameters. Further, the each pipe support assembly 60 may include an attachment bracket 70 configured for attaching the vertical threaded support shaft 61 and a structure supported thereby to a frame of the cutting machine 10, for example to a front wall 12B of the support table 12 of the cutting machine 10. Further, the attachment bracket 70 may include a vertical portion 72 and a horizontal portion 74 extending from a lower end of the vertical portion 72. Further, the horizontal portion 74 may have an elongated slot 75 sized to receive the vertical threaded support shaft 61, wherein a position of the vertical threaded support shaft 61 may be adjusted horizontally along the elongated slot 75 and the vertical threaded support shaft 61 may be adjusted vertically before the vertical threaded support shaft 61 is releasably fixed to the horizontal portion 74 at a desired position by clamping nuts 63A-63B. Further, the attachment bracket 70 may include a hook portion 75 provided at a top end of the vertical portion 72 for hanging the attachment bracket 70 on a frame member of the cutting machine 10. Further, the pipe support assembly 60 may include a tightening bolt 78 threaded through a tapped hole in the vertical portion 72 for engaging the frame member to secure the pipe support assembly 60 in its mounted position. Further, the debris troughs 80 may be configured to catch scrap material as it falls from a workpiece as a result of a cutting operation, and may be mounted to the same frame member of the cutting machine 10 to which the pipe support assemblies 60 are mounted. For example, the debris troughs 80 may be mounted to the front wall 12B of the support table 12 of the cutting machine 10. Further, each debris trough 80, as shown in FIG. 23, may include a trough plate 82 folded to provide a trough receptacle, and one or more attachment brackets 84 fastened to the trough plate 82. Each attachment bracket 84 may be configured to provide support underneath the trough plate 82 and may have a hook portion 85 for hanging the attachment bracket 84 on a frame member of the cutting machine 10. Further, the debris trough 80 may include a tightening bolt 86 threaded through a tapped hole in the each attachment bracket 84 for engaging the frame member of the cutting machine 10 to secure the debris trough 80 in its mounted position. Further, the debris troughs 80 may be mounted end-to-end to form a receptacle beneath the pipe support assemblies 60.

Further, an apparatus comprising the headstock assembly 51, the pipe support assemblies 60, and the debris troughs 80 may be provided in an unassembled or partially assembled state in the form of a kit, whereby the customer may use the kit to retrofit an existing cutting machine (such as the cutting machine 10) with the pipe rotator apparatus 50.

FIG. 21 is a left perspective view of the pipe rotator apparatus 50 of the CNC plasma and/or oxy-fuel cutting machine 10, in accordance with some embodiments.

FIG. 22 is a perspective view of the support assembly 60 of the pipe rotator apparatus 50, in accordance with some embodiments.

FIG. 23 is a perspective view of the debris trough 80 of the pipe rotator apparatus 50, in accordance with some embodiments.

FIG. 24 is a rear perspective view of the headstock assembly 51 of the pipe rotator apparatus 50, in accordance with some embodiments. Further, the headstock assembly 51 may comprise a housing 52. Further, the housing 52 may comprise a front wall 59A and a rear wall 59B.

FIG. 25 is a front perspective view of the headstock assembly 51 of the pipe rotator apparatus 50, in accordance with some embodiments.

FIG. 26 is a front perspective view of the headstock assembly 51 without the front wall 59A, in accordance with some embodiments.

FIG. 27 is a cross-sectional view of the headstock assembly 51 of FIG. 25 taken along a line X-Y, in accordance with some embodiments.

With reference to FIGS. 23-27, the headstock assembly 51 may include an internal spark arrestor 90 associated with an outlet port 53. During a torch cutting operation, sparks are discharged from a workpiece. For safety reasons, it is desirable to contain and quickly extinguish the sparks. The internal spark arrestor 90 may be configured to cooperate with a fume collector connected to the outlet port 53 to arrest sparks discharged from the workpiece during a torch cutting operation utilizing the pipe rotator apparatus 50. Further, a fume collector connected to the outlet port 53 will draw a flow of air and fumes from the region of the cutting torch 2 through the housing 52 of the headstock assembly 51. The internal spark arrestor 90 may be located within the housing 52 and configured to cause the flow of air and fumes, including generated sparks, to travel through a labyrinthine path before reaching the outlet port 53 such that the sparks come into contact with surfaces of the internal spark arrestor 90 and are extinguished before reaching the outlet port 53. Advantageously, the internal spark arrestor 90 avoids the need for a separate spark arrestor external to the headstock assembly 51. Further, the internal spark arrestor 90 may be configured as a plurality of radially nested and axially offset cylindrical rings 91, 92, 93, and 94. For example, a radially innermost cylindrical ring 91 may have one end attached to the rear wall 59B of the housing 52 and may be surrounded over a portion of its axial extent by another cylindrical ring 92 having one end attached to the front wall 59A of the housing 52. This configuration may be repeated, for example by adding another cylindrical ring 93 having one end attached to the rear wall 59B and a further surrounding cylindrical ring 94 attached to the front wall 59A. The cylindrical rings 91, 92, 93, and 94 are sized to provide a radial gap between each pair of overlapping cylindrical rings to permit the flow of air and fumes to reach outlet port 53. Further, the air and fumes may enter the internal spark arrestor 90 at an annular space between a free end of outermost cylindrical ring 94 and the rear wall 59B, travel between an inner surface of the cylindrical ring 94 and an outer surface of the cylindrical ring 93 toward the front wall 59A, advance through an annular space between a free end of the cylindrical ring 93 and the front wall 59A, travel between an inner surface of the cylindrical ring 93 and an outer surface of the cylindrical ring 92 toward the rear wall 59B, advance through an annular space between a free end of the cylindrical ring 92 and the rear wall 59B, travel between an inner surface of the cylindrical ring 92 and an outer surface of the cylindrical ring 91 toward the front wall 59A, advance through an annular space between a free end of the cylindrical ring 91 and the front wall 59A, and travel through the cylindrical ring 91 to reach the outlet port 53. Further, the number of nested cylindrical rings may be less than or more than four rings. Moreover, the internal spark arrestor 90 may be embodied using just one cylindrical ring, for example a single cylindrical ring attached to the rear wall 59B in the manner of the cylindrical ring 91 or 93.

Although the present disclosure has been explained in relation to its preferred embodiment, it is to be understood that many other possible modifications and variations can be made without departing from the spirit and scope of the disclosure.

What is claimed is:

1. An apparatus for facilitating enhancing operations of a computer numerical control (CNC) cutting machine, wherein the CNC cutting machine comprises a support table, a gantry, a carriage, and a main cutting tool, wherein the gantry is movably attached to the support table, wherein the carriage is movably mounted on the gantry, wherein the main cutting tool is attached to the carriage, wherein the gantry transversely extends on the support table, wherein the gantry is configured to move vertically along a length of the support table and the carriage is configured to move horizontally on the gantry along a length of the gantry defining an operation area on the support table, wherein the CNC cutting machine performs at least one operation using the main cutting tool on at least one object disposable on the support table within the operation area, wherein the apparatus comprises:
an extension device attachable to the carriage of the CNC cutting machine, wherein the extension device comprises a first end and a second end, wherein the first end is attachable to a carriage housing of the carriage, wherein the extension device is configured to extend between at least two positions, wherein the extension device comprises at least one tool holder comprised in the second end, wherein the at least one tool holder is configured for removably holding at least one auxiliary cutting tool, wherein the CNC cutting machine further performs the at least one operation on the at least one object using the at least one auxiliary cutting tool.

2. The apparatus of claim 1, wherein the extension device comprises:
at least one ear plate comprising a primary end and a secondary end, wherein the primary end forms the first end, wherein the primary end is attachable to the carriage housing of the carriage using at least one attaching element; and
an extension arm extends between a proximal end and a distal end, wherein the distal end forms the second end, wherein the at least one tool holder is comprised in the distal end, wherein the proximal end is pivotally coupled with the secondary end using at least one pivot element for selectively pivoting the extension arm in relation to the at least one ear plate about a transverse axis defined by the at least one pivot element between the at least two positions, wherein the at least two positions comprises at least one vertical storage position and at least one horizontal extended position.

3. The apparatus of claim 2, wherein the extension arm is associated with a length defined between the proximal end and the distal end, wherein the extension arm transversely extends on the support table in at least a part of the length of the extension arm and the at least one horizontal extended position for defining an extended operation area beyond at least one side of the operation area, wherein the CNC cutting machine further performs the at least one operation using the at least one auxiliary cutting tool on the at least one object disposed within the extended operation area.

4. The apparatus of claim 3, wherein the proximal end of the extension arm is pivotally coupled with the secondary end of the at least one ear plate using the at least one pivot element for selectively pivoting the extension arm in relation to the at least one ear plate about a longitudinal axis defined by the at least one pivot element between a plurality of first positions in the at least one horizontal extended position, wherein the longitudinal axis is orthogonal to the transverse axis.

5. The apparatus of claim 4, wherein the extension arm in a first position of the plurality of first positions is configured for defining a first extended operation area beyond the operation area on at least one first side of the operation area in the at least one horizontal extended position of the extension arm based on the selectively pivoting of the extension arm in relation to the at least one ear plate about the longitudinal axis, wherein the CNC cutting machine further performs the at least one operation using the at least one auxiliary cutting tool on the at least one object disposed within the first extended operation area.

6. The apparatus of claim 2, wherein the at least one ear plate comprises at least one clamping lever configured to be removably mated with at least one slot comprised in at least one proximal portion of the extension arm for releasably holding the extension arm in at least one selected position of the at least two positions.

7. The apparatus of claim 1, wherein the extension device is detachably attachable to the carriage of the CNC cutting machine using at least one attachment element, wherein a first attachment part of the at least one attachment element is comprised in the first end of the extension device and a second attachment part of the at least one attachment element is comprised in at least one portion of the carriage housing, wherein the first attachment part of the second attachment part is configured to be detachably attached.

8. The apparatus of claim 5, wherein the support table is configured for supporting the at least one object disposed within a top surface area of a top surface of the support table, wherein the top surface area comprises the operation area, wherein the CNC machine further performs the at least one operation on the at least one object disposed within the top surface area based on the supporting.

9. The apparatus of claim 8 further comprising at least one mounting apparatus mountable on at least one side of the support table using at least one fastening mechanism, wherein the at least one mounting apparatus is configured for supporting the at least one object disposed within at least one of the extended operation area and the first extended operation area, wherein the CNC machine further performs the at least one operation on the at least one object disposed within the at least one of the extended operation area and the first extended operation area based on the supporting.

10. The apparatus of claim 9, wherein the at least one mounting apparatus comprises a rotator apparatus, wherein the rotator apparatus comprises a headstock assembly, one or more pipe support assemblies, and one or more debris troughs, wherein the one or more pipe support assemblies is mounted on the at least one side of the support table, wherein the one or more pipe support assemblies is configured for rotatably supporting the at least one object disposed on the one or more pipe support assemblies.

11. The apparatus of claim 10, wherein the one or more debris troughs is mounted on the at least one side of the support table, wherein the one or more debris troughs forms one or more receptacles, wherein the one or more debris troughs is configured for receiving at least one scrap material generated by the at least one object based on the at least one operation performed on the at least one object.

12. The apparatus of claim 11, wherein the headstock assembly is mounted on the at least one side of the support table, wherein the headstock assembly comprises a gearbox, wherein an input shaft of the gearbox is couplable with an output motor shaft of a drive motor, wherein the drive motor rotates the output motor shaft, wherein the headstock assembly comprises a chuck, wherein a rear end of the chuck is rotatably coupled with an output shaft of the gearbox, wherein a front end of the chuck is configured to be rotatably coupled with a first end of the at least one object, wherein the chuck is configured to rotate the at least one object based on a rotation received by the chuck on the rear end of the chuck through the output shaft.

13. The apparatus of claim 12, wherein the headstock assembly further comprises a spark arrestor disposed within a housing of the headstock assembly, wherein the spark arrestor is configured for arresting at least one spark generated by the at least one object, wherein the spark arrestor is configured to cooperate with a fume collector connectable to an outlet port disposed on the housing, wherein the fume collector is configurable for drawing air from at least one region associated with the at least one object through the housing, wherein the drawing of the air draws the at least one spark into the spark arrestor, wherein the at least one spark is extinguished by coming in contact with at least one surface of the spark arrestor.

14. The apparatus of claim 13, wherein the spark arrestor comprises a plurality of cylindrical rings, wherein the plurality of cylindrical rings is disposed coaxially, wherein the plurality of cylindrical rings is radially nested and axially offsetted, wherein the plurality of cylindrical rings comprises a first plurality of cylindrical rings and a second plurality of cylindrical rings, wherein a primary end of each first cylindrical ring of the plurality of first cylindrical rings is attached to an inner surface of a front wall of the housing, wherein a primary end of each second cylindrical ring of the plurality of second cylindrical rings is attached to an inner surface of a rear wall of the housing, wherein the each first cylindrical ring partially encompasses the each second cylindrical ring by providing a radial gap between the each first cylindrical ring and the each second cylindrical ring, wherein a secondary end of the each first cylindrical ring is not attached to the inner surface of the rear wall, wherein a secondary end of the each second cylindrical ring is not attached to the inner surface of the front wall, wherein the plurality of cylindrical rings is configured for forming a plurality of paths for the at least one spark based on coaxially disposing of the plurality of cylindrical rings and radially nesting and axially offsetting of the plurality of cylindrical rings, wherein the at least one spark travels through the plurality of paths for coming in contact with the at least one surface of the spark arrestor.

15. An apparatus for facilitating enhancing operations of a computer numerical control (CNC) cutting machine, wherein the CNC cutting machine comprises a support table, a gantry, a carriage, and a main cutting tool, wherein the gantry is movably attached to the support table, wherein the carriage is movably mounted on the gantry, wherein the main cutting tool is attached to the carriage, wherein the gantry transversely extends on the support table, wherein the gantry is configured to move vertically along a length of the support table and the carriage is configured to move horizontally on the gantry along a length of the gantry defining an operation area on the support table, wherein the CNC cutting machine performs at least one operation using the main cutting tool on at least one object disposable on the support table within the operation area, wherein the apparatus comprises:
an extension device attachable to the carriage of the CNC cutting machine, wherein the extension device comprises a first end and a second end, wherein the first end is attachable to a carriage housing of the carriage, wherein the extension device is configured to extend between at least two positions, wherein the extension device comprises at least one tool holder comprised in the second end, wherein the at least one tool holder is configured for removably holding at least one auxiliary cutting tool, wherein the CNC cutting machine further performs the at least one operation on the at least one object using the at least one auxiliary cutting tool, wherein the extension device comprises:
at least one ear plate comprising a primary end and a secondary end, wherein the primary end forms the first end, wherein the primary end is attachable to the carriage housing of the carriage using at least one attaching element; and
an extension arm extends between a proximal end and a distal end, wherein the distal end forms the second end, wherein the at least one tool holder is comprised in the distal end, wherein the proximal end is pivotally coupled with the secondary end using at least one pivot element for selectively pivoting the extension arm in relation to the at least one ear plate about a transverse axis defined by the at least one pivot element between the at least two positions, wherein the at least two positions comprises at least one vertical storage position and at least one horizontal extended position.

16. The apparatus of claim 15, wherein the extension arm is associated with a length defined between the proximal end and the distal end, wherein the extension arm transversely extends on the support table in at least a part of the length of the extension arm and the at least one horizontal extended position for defining an extended operation area beyond at least one side of the operation area, wherein the CNC cutting machine further performs the at least one operation using the at least one auxiliary cutting tool on the at least one object disposed within the extended operation area.

17. The apparatus of claim 16, wherein the proximal end of the extension arm is pivotally coupled with the secondary end of the at least one ear plate using the at least one pivot element for selectively pivoting the extension arm in relation to the at least one ear plate about a longitudinal axis defined by the at least one pivot element between a plurality of first positions in the at least one horizontal extended position, wherein the longitudinal axis is orthogonal to the transverse axis.

18. The apparatus of claim 17, wherein the extension arm in a first position of the plurality of first positions is configured for defining a first extended operation area beyond the operation area on at least one first side of the operation area in the at least one horizontal extended position of the extension arm based on the selectively pivoting of the extension arm in relation to the at least one ear plate about the longitudinal axis, wherein the CNC cutting machine further performs the at least one operation using the at least one auxiliary cutting tool on the at least one object disposed within the first extended operation area.

19. The apparatus of claim 15, wherein the at least one ear plate comprises at least one clamping lever configured to be removably mated with at least one slot comprised in at least one proximal portion of the extension arm for releasably holding the extension arm in at least one selected position of the at least two positions.

20. The apparatus of claim 15, wherein the extension device is detachably attachable to the carriage of the CNC cutting machine using at least one attachment element, wherein a first attachment part of the at least one attachment element is comprised in the first end of the extension device and a second attachment part of the at least one attachment element is comprised in at least one portion of the carriage housing, wherein the first attachment part of the second attachment part is configured to be detachably attached.
